(19) United States
(12) Patent Application Publication
(10) Pub. No.: US 2012/0217799 A1
(43) Pub. Date: Aug. 30, 2012

(54) Central Battery Interconnected Smoke Detector System with Single Wire AC and DC Pass-Through Relay

(76) Inventors: Preston Palmer, Gilbert, AZ (US); Wesley Palmer, Mesa, AZ (US); Larkin Palmer, Payson, AZ (US)

(21) Appl. No.: 13/407,443

(22) Filed: Feb. 28, 2012

Related U.S. Application Data
(60) Provisional application No. 61/464,115, filed on Feb. 28, 2011.

(51) Int. Cl. H02J 3/00

(52) U.S. Cl. 307/22

(57) ABSTRACT

An AC powered and DC battery backup powered interconnected smoke alarm/detector system that provides battery backup to each and all smoke alarms/detectors within a dwelling using a single, centrally located rechargeable backup battery. Both AC power and DC backup power sources are distributed and provided to each and all smoke alarms/detectors through the same electrical high voltage wiring via an AC and DC Pass-Through Relay.

### CROSS-REFERENCE TO RELATED APPLICATIONS

Application Number:

61/464,115

Filing Date:

Feb. 28, 2011

Provisional Patent Application

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC

“Not Applicable”

### BACKGROUND OF THE INVENTION

This invention pertains to residential smoke alarm/detector systems and their current issues and failures.
“Almost two-thirds of home fire deaths in 2005-2009 resulted from fires in homes with no smoke alarms or no working smoke alarms.
When smoke alarms fail to operate, it is usually because batteries are missing, disconnected or dead.” (Source(s):
   NFPA—National Fire Protection Association, www.NFPA.org)
      (Note: The following smoke alarm and smoke detector wording, while slightly different, is meant to portray the same meaning.)

In the United States many states require that smoke alarms/detectors be present in both residential and commercial applications, especially in new construction. Current smoke alarm technologies vary by the way they are connected and powered.

An example of the most common residential smoke alarm installation methods are as follows:

1.) Smoke alarm powered by a local battery only, not hardwired and not connected to any AC or DC electrical system.

2.) Smoke alarm powered by a hardwired AC electrical system with a local battery backup and Interconnected, which means the smoke detectors are wired together and communicate so if one detector sounds an alarm they will all sound an alarm.

According to www.NFPA.org, “The Most Common Reason Smoke Alarms Failed to Operate in Home Structure Fires 2005-2009:”

1.) 50%—Missing or disconnected battery
2.) 23%—Dead or discharged battery
3.) 9%—Unclassified reason for failure
4.) 7%—Hardwire power failure, shut-off or disconnect

We can see that “missing” or “disconnected” batteries are the number one reason for smoke alarm failures in the United States. So what causes these “missing” or “disconnected” batteries?

According to www.NFPA.org, “nuisance alarms” and “chirping” of smoke alarms indicating low battery were the reason smoke alarms were disconnected.

“When smoke alarms should have operated but did not do so, it was usually because batteries are missing, disconnected or dead. People are most likely to remove or disconnect batteries because of nuisance activations. Sometimes the chirping to warn of a low battery is interpreted as a nuisance alarm.”

“High ceilings posed a challenge in dealing with nuisance alarms and for battery changes.

“To some people, the stress of nuisance alarms outweighs the benefit of smoke alarm protection.

The NFPA recommends: “Replacing batteries in all smoke alarms at least once a year.”

It's clear that smoke detectors in a dwelling that all contain separate backup batteries and that need to be replaced often could be viewed as a nuisance, especially in larger homes that may have several dozen smoke alarms.

Because of the “nuisances” of current smoke alarm/detector technologies we decided to design and build a safer, alternative smoke alarm system that requires less user maintenance.

### BRIEF SUMMARY OF THE INVENTION

This Invention offers a safer, alternative smoke alarm/detector system that requires less user maintenance. The invented new smoke detector system uses only one single rechargeable backup battery that is housed in a single convenient location to backup all smoke detectors in a dwelling. The invented system is installed using a dwellings existing interconnected electrical smoke alarm wiring (no retrofit needed) and supplies both AC current and DC backup current to smoke detectors using the same existing high voltage electrical wiring. The AC and DC current is separated via AC and DC relays which pass-through the available supplied current to power and maintain the smoke alarms. When AC current is active the relays instantly shut-off DC current and pass-through AC current to smoke alarms. When AC current is not active (power outage) the relays instantly pass-through DC backup current. The single DC backup battery charges when AC current is present and when AC current is not present the DC backup battery can continue to charge via solar.

This new smoke alarm system would solve the current “nuisance” and “maintenance” issues with existing smoke alarm technologies and could greatly reduce the most common reason why current smoke alarms fail, which is because of “missing or “disconnected” batteries.

### BRIEF DESCRIPTION OF THE SEVERAL VIEWS OF THE DRAWING

FIG. 1A: Depiction of a typical residential home floor plan used only for displaying typical electrical wiring for smoke alarms/detectors.

FIG. 1B: Depiction of typical electrical wiring for interconnected smoke alarms/detectors homerun to electrical panel.

FIG. 1C: Exploded view of the inside of a typical electrical panel which houses electrical circuits including the smoke alarm wiring.

FIG. 1D: Exploded view of the inside of invented Central Battery Interconnected Smoke Detector System panel and shown mounted next to existing electrical panel. This panel consists of two compartments (sides) a high voltage electrical side on left and a low voltage side on right.

FIG. 1E: Depiction of AC and DC Pass-Through Relay. This Relay controls the input and output of AC and DC currents across existing electrical wiring to supply (power) both AC current and DC current, separately. In this case is used to supply AC current and DC backup current to smoke alarms/detectors in dwelling

FIG. 1F: Depiction of isolated electrical smoke alarm wiring homerun to existing electrical panel and shown being re-routed via conduit to invented Central Battery Interconnected Smoke Detector System panel.

FIG. 1G: Depiction of an isolated “hot” circuit from electrical panel breaker being routed via conduit to invented Central Battery Interconnected Smoke Detector System panel to provide AC power to be used for system power and to power AC current to smoke alarms.

FIG. 1H: Depiction of panel junctions joined by conduit between Central Battery Interconnected Smoke Detector System panel and existing electrical panel.

FIG. 1I Depiction of DC low voltage junction from low voltage, right side of panel to high voltage, left side of panel

FIG. 1J: Depiction of AC high voltage power supply outlet for low voltage right side of panel.

FIG. 1K: Depiction of low voltage controller which provides DC current (power) to smoke alarms/detectors, recharges backup battery and provides and monitors system status to and from smoke alarms/detectors.

FIG. 1L: Depiction of DC rechargeable backup battery that is user-serviceable.

FIG. 1M: Depiction of solar panel used to charge DC rechargeable backup battery in the event of a power outage.

FIG. 1N: Exploded view of invented Central Battery Interconnected Smoke Detectors. The detectors operate on both AC and DC currents and receive power via a dwellings existing electrical wiring from the Central Battery Interconnected Smoke Detector System panel. The Smoke Detectors are interconnected and communicate with each other as well as with the Central Battery System low voltage controller. (Interconnected means that if one smoke detector sounds an alarm all the smoke detectors will sound an alarm.)

FIG. 1O: Depiction of AC Power terminals on relay that energize relay when AC current is present and de-energize when AC not present.

FIG. 1P: Depiction of AC terminals on relay that when AC is present the relay switches on and connects AC terminals with electrical smoke alarm wiring terminals and passes through AC current for power. DC terminals are disconnected.

FIG. 1Q: Depiction of DC terminals on relay that when AC is not present the relay switches off and connects DC terminals with electrical smoke alarm wiring terminals and passes through DC current for power. AC terminals are disconnected. DC current is shown coming from low voltage controller.

FIG. 1R: Depiction of electrical smoke alarm wiring terminals that feed to smoke alarms/detectors.

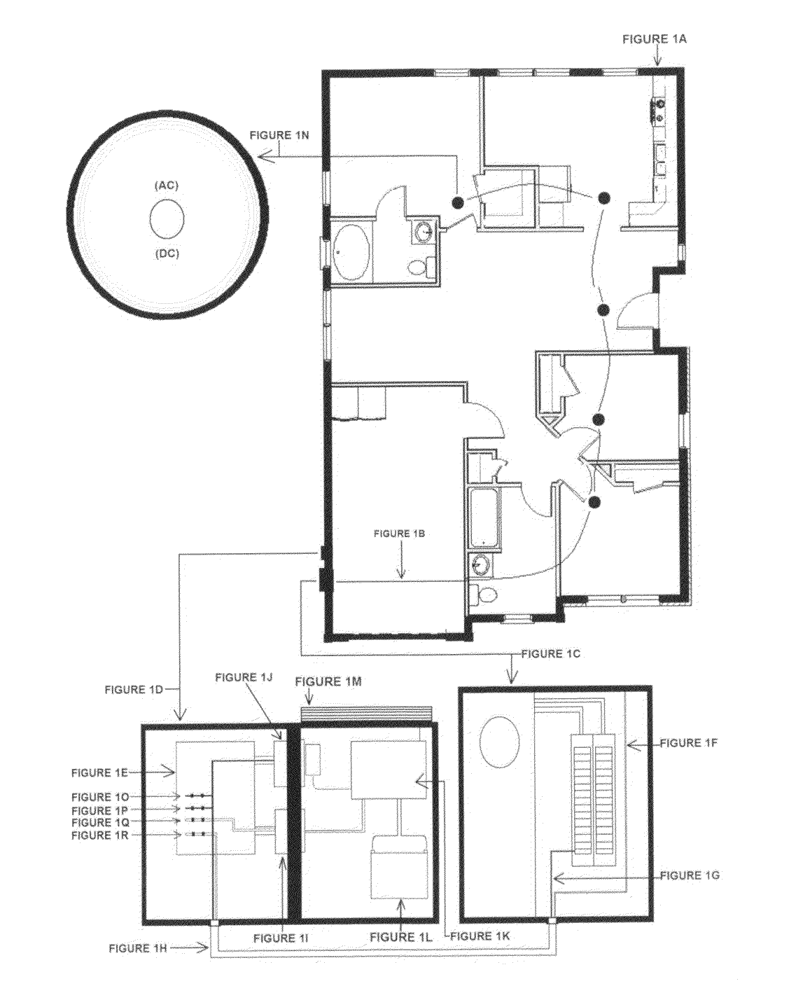

### DETAILED DESCRIPTION OF THE INVENTION

The Central Battery Interconnected Smoke Detector System with AC and DC Pass-Though Relay is a safer and more effective method for smoke alarms.

As noted previously by the NFPA, the number one cause of current smoke alarm failures is due to “missing” or “disconnected” batteries. The technology behind today's smoke alarm industry is old and outdated. Smoke alarm manufacturers don't seem to recognize the fact that most people find it too inconvenient (or costly) to replace the many batteries needed for each and all smoke detectors in a dwelling, especially considering smoke detectors are usually located high on ceilings and require a ladder to access them. Replacing each battery in each smoke detector while having to use a ladder can take a very long time.

This invention came about because of our own “inconvenience” with and the “nuisance” of the current, but “required” smoke alarms.

A smoke detection system in a home should have a single and centrally located backup battery, that's rechargeable and easy to access!

### This is How it's Made:

The Central Battery Interconnected Smoke Detector System with Single Wire AC and DC Pass-Through Relay invention will be referred to as “Central Battery Panel”, “ACDC Pass-Through Relay” and “ACDC Smoke Detector” for this description.

The Central Battery Panel consists of two parts; the low voltage side, right side and the high voltage side, left side. The panel is an indoor/outdoor weatherproof panel (similar to a very small electrical panel) that is installed near an existing electrical panel of a dwelling which contains the isolated electrical wiring used for smoke alarms. The high voltage side which houses the ACDC Pass-Through Relay has a conduit opening that is used for connection to the electrical panel. The isolated electrical wiring for the smoke detectors in the electrical panel is re-routed along with a newly made “hot” feed from electrical panel breaker to the high voltage side of Central Battery Panel and connected to ACDC Pass-Through Relay. The “hot” feed is also used to make up an outlet inside the Central Battery Panel to be used for power to the low voltage side.

The low voltage side houses the low voltage controller, power supply, rechargeable backup battery and solar panel. The low voltage controller is connected to the low voltage junction box which is also connected to the ACDC Pass-Through Relay and supplies DC low voltage backup current.

The ACDC Smoke Detectors are installed in the same fashion as any other interconnected smoke alarm using the three wires (two will work as well). The ACDC Smoke Detectors will not need any batteries replaced within them.

### When AC Current is Active:

With AC on the ACDC Pass-Through Relay instantly opens the AC terminals and closes the DC terminals allowing AC current to be passed through and powers all the ACDC Smoke Detectors on AC current. The ACDC Smoke Detectors function normally and display a visible green LED light indicating AC power.

### When AC Current in Not Active:

With AC off (power outage) the ACDC Pass-Through Relay instantly closes the AC Terminals and opens the DC terminals as DC current is passed through and powers all'the ACDC Smoke Detectors on DC backup current. The ACDC Smoke Detectors function normally with the exception of a visible red LED light indicating DC backup power. The solar panel continues to charge the DC battery for prolonged battery efficiency.

### How the ACDC Pass-Through Relay works:

The ACDC Pass-Through Relay is an electromechanical relay system.

Electromechanical relays are electrically operated switches. AC and DC electromechanical relays are combined to form the ACDC Pass-Through Relay. When an AC operated relay receives AC power it opens and simultaneously closes a terminal. Likewise, when a DC operated relay receives DC power it opens and simultaneously closes a terminal. When AC power is present the relays simultaneously open and close terminals permitting AC power while restricting DC power. When AC power is not present the relays simultaneously open and close terminals permitting DC power.

So, by utilizing a dwellings existing electrical wiring and isolating it with the ACDC Pass-Through Relay the invention can send both AC current and DC current (power) across the same electrical wiring, separately, without collision.

1. The Central Battery Interconnected Smoke Detector with Single Wire AC and DC Pass-Through Relay invention is the only smoke alarm/detection system that powers each and all smoke alarms/detectors via both AC high voltage current and DC low voltage backup current, separately, through the same high voltage electrical wiring via an AC and DC relay system within a dwelling and that does not rely on batteries in each smoke alarm/detector for backup and is backed up by one single and centrally located rechargeable battery that is also charged via solar energy.
